(19) United States
(12) Patent Application Publication
(10) Pub. No.: US 2025/0344139 A1
(43) Pub. Date: Nov. 6, 2025

(54) PROVIDING PROXIMITY-BASED DATA CENTER FOR INTER-OPERATOR ROAMING

(71) Applicant: Charter Communications Operating, LLC, St. Louis, MO (US)

(72) Inventor: Venkata Ramana Divvi, Centennial, CO (US)

(73) Assignee: Charter Communications Operating, LLC, St. Louis, MO (US)

(21) Appl. No.: 18/654,722

(22) Filed: May 3, 2024

(51) Int. Cl. H04W 48/18; H04W 48/16; H04W 64/00

(52) U.S. Cl. CPC H04W 48/18; H04W 48/16; H04W 64/003

(57) ABSTRACT

A first network operator (A), having a roaming agreement with a second network operator (B), has a communication system having multiple network data centers (NDCs). When user equipment (UE) of a customer of Operator A requests network access via an NDC of Operator B, Operator A's communication system selects one of its NDCs to provide that network access based on location information associated with the UE. In this way, the network access provided to the UE via Operator B's comm system will have lower latency than if one of Operator A's other NDCs were selected to provide that network access. Depending on the implementation the location information may be explicitly provided to Operator B's NDC or coded at either Operator B's NDC or Operator A's NDC.

### BACKGROUND

### Field of the Disclosure

The present disclosure relates to wireless communications and, more specifically but not exclusively, to 5G wireless communication networks that deploy geo-redundant Network Repository Functions (NRFs) and enable inter-operator roaming.

### Description of the Related Art

This section introduces aspects that may help facilitate a better understanding of the disclosure. Accordingly, the statements of this section are to be read in this light and are not to be understood as admissions about what is prior art or what is not prior art.

A network repository function (NRF) stores information about other network functions in the form of profiles, supporting the discovery procedures and status monitoring and notifications delivery. In 5G core networks, network functions register their configurations and support services in a designated NRF. These network functions are allowed to update their configurations, like their operational status, dynamically.

It is known to provision geo-redundant NRFs in different locations to provide backup in case one of the NRFs fails. Although each NRF with geo-redundant mode of operation can support any of the network's functions from geo-redundant sites, to reduce latency in the connection establishment and end-user data, an NRF will provide information to a network function that is physically close to the UE based on the UE's current location.

If the UE, however, has roamed to a different (i.e., visited) network that has a roaming agreement with the consumer's home network, the home network's NRF may provide information that results in the UE being connected to a network function that is far from the current location of the UE, thereby resulting in undesirably high latency.

### SUMMARY

Problems in the prior art are addressed in accordance with the principles of the present disclosure by using location information associated with a UE or serving network function in a visited network to connect the UE to a relatively close home network function when the UE is communicating through a visited network that has a roaming agreement with the UE's home network in order to reduce latency of that connection.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a block diagram of a prior-art wireless communication (comm) system run by a network operator;

FIG. 2 is a block diagram representing two different prior-art wireless comm systems;

FIG. 3 is a block diagram of the two wireless comm systems of FIG. 2 for the situation in which a UE of one of Operator A's customers has roamed out of the coverage range of Operator A's comm system and into the coverage range of Operator B's comm system;

FIG. 4 is a block diagram representing a proximity-based solution to the problem described in the context of FIG. 3;

FIG. 5 is a message flow diagram representing the sequence of messages transmitted within and between the comm systems of FIG. 4 for implementations in which the NF request received at Operator B's NRF either contains or is accompanied by explicit location information associated with the requesting UE;

FIG. 6 is a message flow diagram representing the sequence of messages transmitted within and between the comm systems of FIG. 4 for implementations in which the location information associated with a UE is coded at Operator B's NRF;

FIG. 7 is a message flow diagram representing the sequence of messages transmitted within and between the comm systems of FIG. 4 for implementations in which the location information associated with a UE is coded at Operator A's NRF; and

FIG. 8 is a simplified hardware block diagram of an example node that can be used to implement any of the NDCs of FIGS. 1-7.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

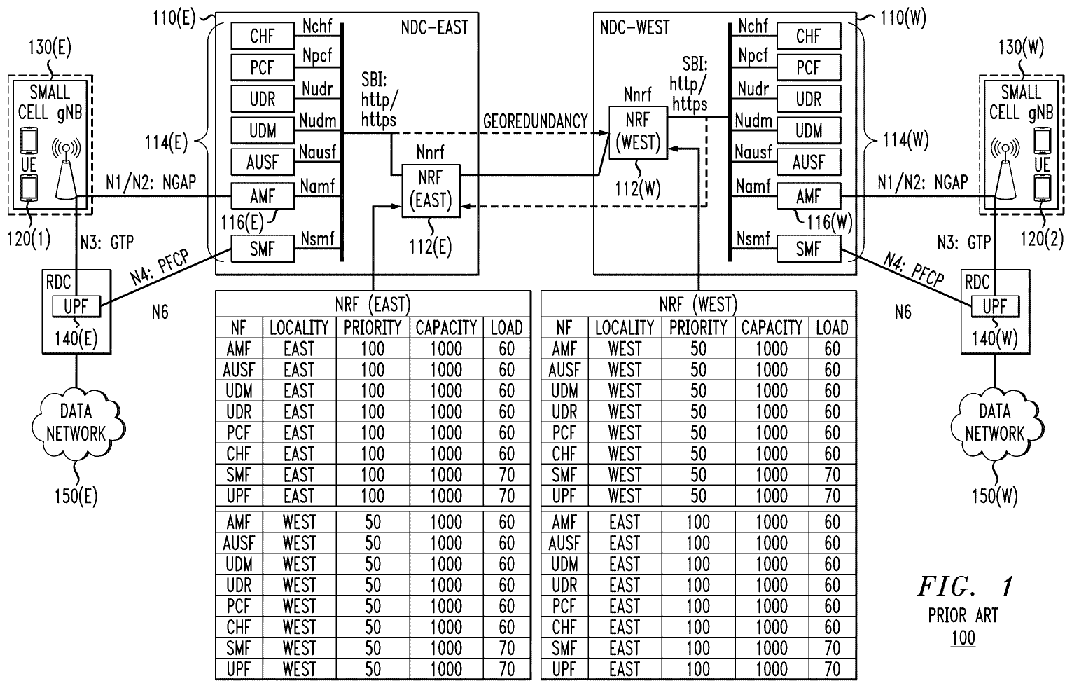

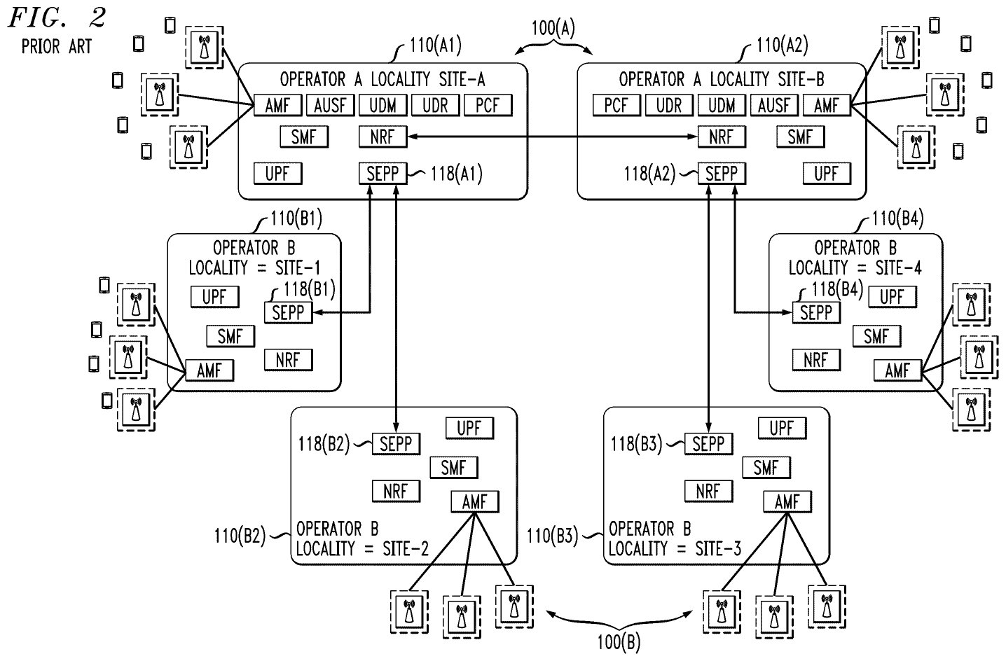

FIG. 1 is a block diagram of a prior-art wireless communication (comm) system 100 run by a network operator. As shown in FIG. 1, comm system 100 has two national data centers (NDCs): an eastern NDC 110(E) deployed in the eastern half of the continental U.S. and a western NDC 110(W) deployed in the western half of the continental U.S. Each NDC 110 has a corresponding, redundant network repository function (NRF) 112 and a corresponding, redundant set of network functions (NFs) 114 that enable each NDC 110 to support network access from the UEs 120 of any of the network operator's subscribers.

As described previously, however, in order to reduce latencies, comm system 100 is designed to connect each subscriber UE 120 with NFs 114 that are physically closer to the UE 120. For example, when UE 120(1) accesses comm system 100 via base station (e.g., small cell gNB) 130(E) and control plane function (AMF 116(E)), NRF 112(E) at NDC 110(E) recognizes that the request for NF service arrives via AMF (Access and Mobility Management Function) 116(E). As such, NRF 112(E) connects UE 120(1) to NFs 114(E). Similarly, when UE 120(2) accesses comm system 100 via base station 130(W) and AMF 116(W), NRF 112(W) at NDC 110(W) recognizes that the request for NF service arrives via AMF 116(W). As such, NRF 112(W) connects UE 120(2) to NFs 114(W).

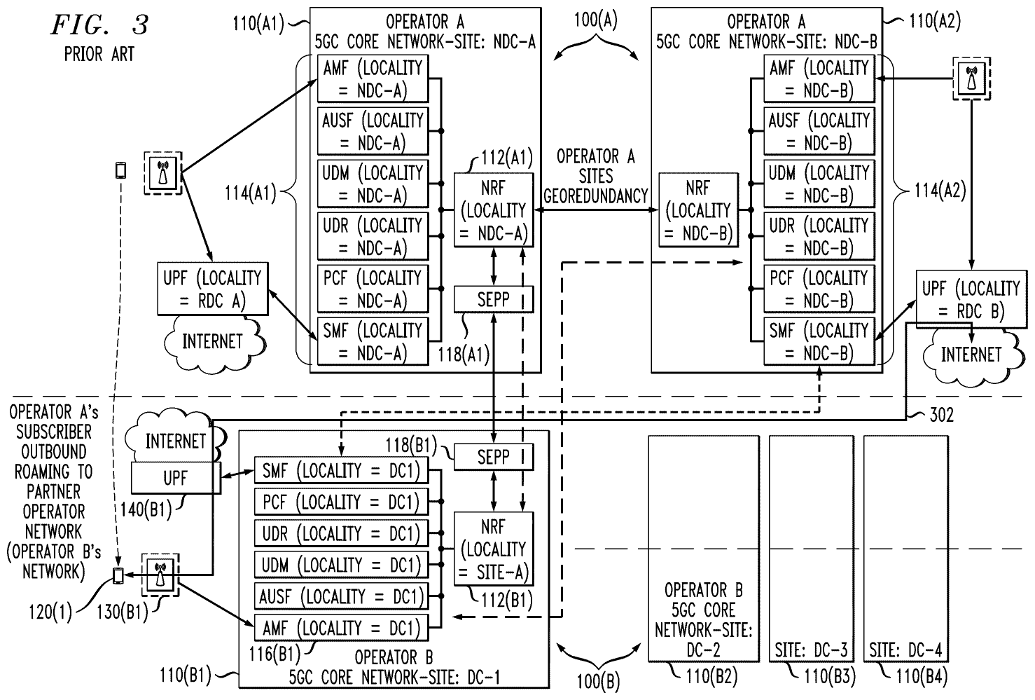

FIG. 2 is a block diagram representing two different prior-art wireless comm systems: a first comm system 100(A) run by Network Operator A having two NDCs 110(A1) and 110(A2) and a second comm system 100(B) run by Network Operator B having four NDCs 110(B1)-110(B4), where the two network operators have a roaming agreement that provides network access to the UEs 120 of each other's customers. As shown in FIG. 2, this inter-operator network access is enabled by (i) the security edge protection proxy (SEPP) 118(A1) of Operator A's NDC 110(A1) communicating with the SEPPs 118(B1) and 118(B2) of Operator B's respective NDCs 110(B1) and 110(B2) and (ii) the SEPP 118(A2) of Operator A's NDC 110(A2) communicating with the SEPPs 118(B3) and 118(B4) of Operator B's respective NDCs 110(B3) and 110(B4).

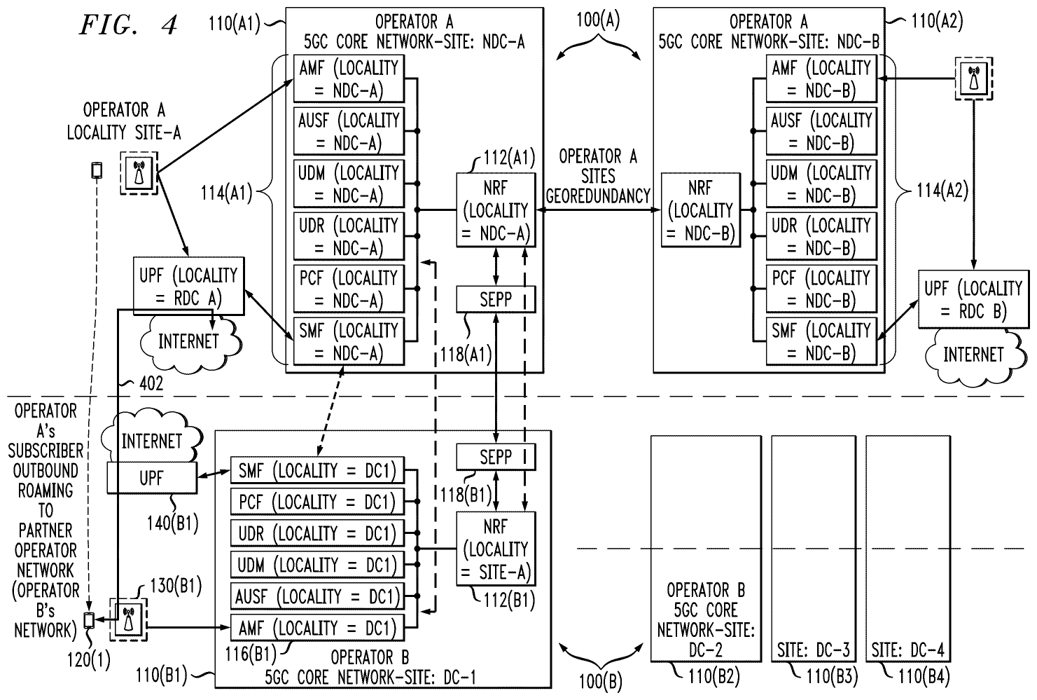

FIG. 3 is a block diagram of the two prior-art wireless comm systems 100(A) and 100(B) of FIG. 2 for the situation in which UE 120(1) of one of Operator A's customers has roamed out of the coverage range of Operator A's comm system 100(A) and into the coverage range of Operator B's comm system 100(B). In particular, UE 120(1) accesses network functions like AMF/SMF/UPF located in Operator B's NDC 110(B1) via base station 130(B1).

When NRF 112(B1) of Operator B's NDC 110(B1) receives the NF request of UE 120(1), NRF 112(B1) recognizes that UE 120(1) is associated with a customer of Operator A. As such, NRF 112(B1) sends the NF request to NRF 112(A1) of Operator A's NDC 110(A1) via SEPPs 118(B1) and 118(A1). In response, Operator A's NRF 112(A1) transmits, back to Operator B's NRF 112(B1) via SEPPs 118(A1) and 118(B1), (i) information about NFs 114(A1) in Operator A's NDC 110(A1) and (ii) information about NFs 114(A2) in Operator A's NDC 110(A2).

Having received both sets of information, Operator B's NRF 112(B1) selects either Operator A's NFs 114(A1) or Operator A's NFs 114(A2) to provide the requested NFs to UE 120(1). Depending on the particular selection algorithm employed using preferred locality parameters received in the request, even though UE 120(1) is physically closer to Operator A's NDC 110(A1), Operator B's NRF 112(B1) could select NFs 114(A2) of Operator A's NDC 110(A2). In that case, the resulting network access 302 provided to UE 120(1) could have latency higher than if NFs 114(A1) of Operator A's NDC 110(A1) had been selected for UE 120(1).

FIG. 4 is a block diagram representing a proximity-based solution to the problem described in the context of FIG. 3. In particular, the decision as to which NFs to select for UE 120(1) of FIG. 3 is based, at least in part, on location information associated with UE 120(1). Depending on the particular implementation, this location information can take different forms.

In some possible implementations, the NF request for UE 120(1) that arrives at Operator B's NRF 112(B1) is accompanied by explicit location information, such as the physical location of the UE 120(1) itself, the physical location of Operator B's base station 130(B1), and/or the physical location of Operator B's AMF 116(B1). In any of those implementations, Operator A's NRF 112(A1) requests, receives, and uses that location information from Operator B's NRF 112(B1) to select, in the situation of FIGS. 3 and 4, NFs 114(A1) of Operator A's NDC 110(A1) instead of NFs 114(A2) of Operator A's NDC 110(A2) for UE 120(1).

In other possible implementations, the location information is coded into one or both NRFs 112 based on the relationships inherent in the inter-operator SEPP-to-SEPP connections. In particular, assuming that connections are themselves based on the physical proximity of NDCs, given that Operator B's SEPP 118(B1) communicates only with Operator A's SEPP 118(A1) and not with Operator A's SEPP 118(A2), that relationship could be coded into either Operator B's NRF 112(B1) or Operator A's NRF 112(A1). If the relationship is coded into Operator B's NRF 112(B1), then, whenever Operator B's NRF 112(B1) receives an NF request from a UE of one of Operator A's customers, Operator B's NRF 112(B1) will be able to identify Operator A's NDC 110(A1) as the NDC that should provide NF service to that UE. If, instead, the relationship is coded into Operator A's NRF 112(A1), then, whenever Operator A's NRF 112(A1) receives an NF request from Operator B's NRF 112(B1), Operator A's NRF 112(A1) will know to select NFs 114(A1) for the UE. As used herein, the term “location information associated with a UE” includes these situations in which the relationship is coded into either Operator B's NRF 112(B1) or Operator A's NRF 112(A1).

In any of these implementations, the resulting network access 402 of FIG. 4 provided to UE 120(1) will be more likely to have lower latency than if NFs 114(A2) of Operator A's NDC 110(A2) had been selected for UE 120(1).

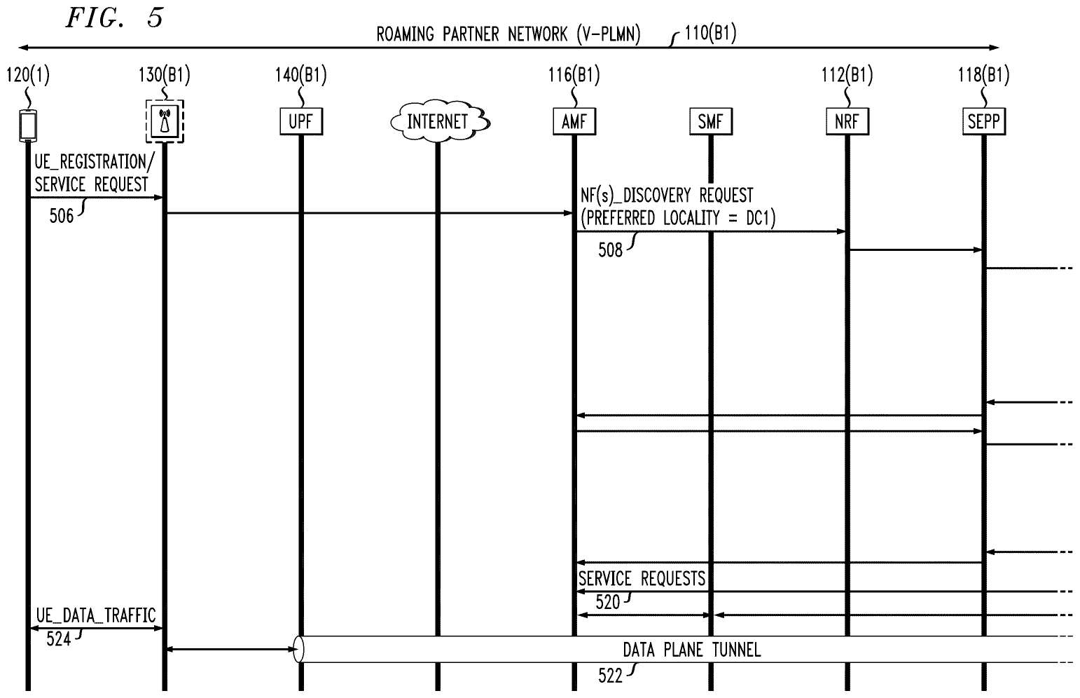

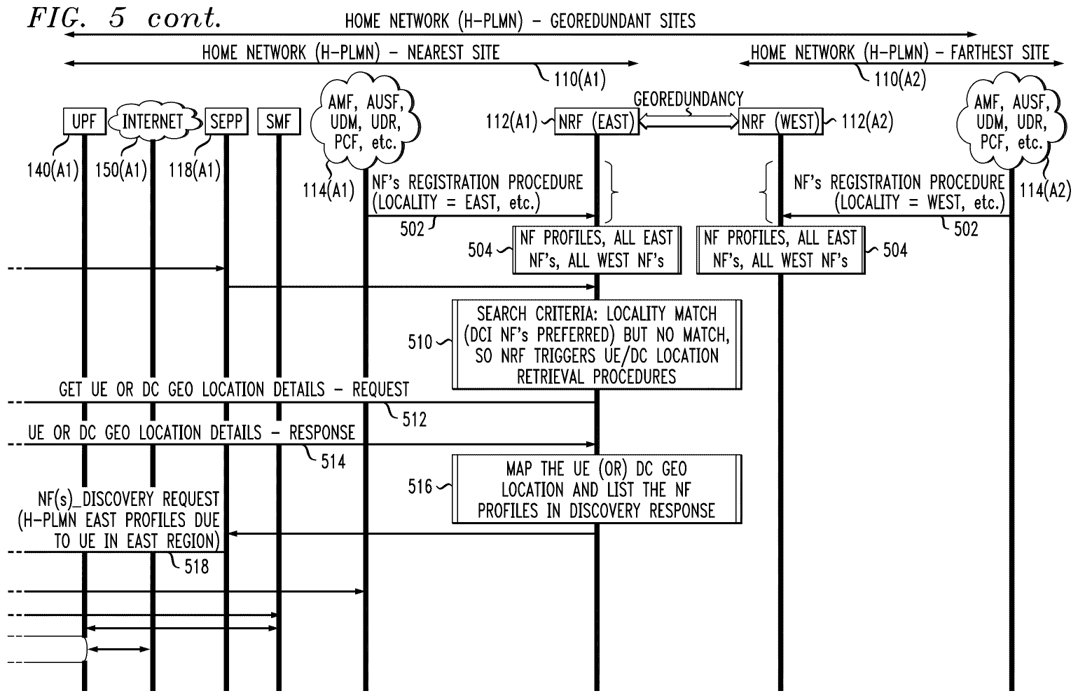

FIG. 5 is a message flow diagram representing the sequence of messages transmitted within and between the comm systems 100(A) and 100(B) of FIG. 4 for implementations in which the NF request received at Operator B's NRF 112(B1) either contains or is accompanied by explicit location information associated with UE 120(1).

As represented in FIG. 5, in Step 502, NF registration procedures are performed at Operator A's NDCs 110(A1) and 110(A2) to create NF profiles at Step 504 for all of Operator A's NFs in both NRFs 112(A1) and 112(A2).

In Step 506, UE 120(1) transmits an NF service request to Operator B's NDC 110(B1) via base station 130(B1) and UPF 140(B1). In Step 508, the NF service request is processed at Operator B's NDC 110(B1) and transmitted from Operator B's NRF 112(B1) via Operator B's SEPP 118(B1) and Operator A's SEPP 118(A1) to Operator A's NRF 112(A1). This NF service request contains a preferred locality set to a value defined by Operator B, which locality is unknown to Operator A. As such, in Step 510, Operator A's NRF 112(A1) searches its database for the specified preferred locality but is unable to find it.

As such, in Step 512, as part of a location retrieval procedure, Operator A's NRF (A1) transmits, via SEPPs 118(A1) and 118(B1), a request for location information associated with UE 120(1). In response, in Step 514, Operator B's AMF (or LMF) transmits, via SEPPs 118(B1) and 118(A1), a response with the requested location information to Operator A's NRF 112(A1).

In Step 516, Operator A's NRF 112(A1) uses the received location information to identify the NFs 114(A1) at Operator A's NDC 110(A1) and, in Step 518, Operator A's NRF 112(A1) transmits the corresponding NF profiles, via SEPPs 118(A1) and 118(B1), to Operator B's NDC 110(B1). In Step 520, Operator B's NFs (e.g., AMF, SMF) communicates with Operator A's NFs 114(A1) regarding service requests for UE 120(1) to establish a data plane tunnel 522 for UE 120(1) between Operator B's UPF 140(B1) and Operator A's UPF 140(A1).

In Step 524, UE 120(1) accesses the Internet 150(A1) via the data plane tunnel 522 as represented by network access 402 of FIG. 4.

Note that, in alternative implementations, the explicit location information received by Operator B's NRF 112(B1) may be explicitly included in the message transmitted from Operator B's NRF 112(B1) to Operator A's NRF 112(A1) in Step 508. In that case, Steps 510-514 may be omitted.

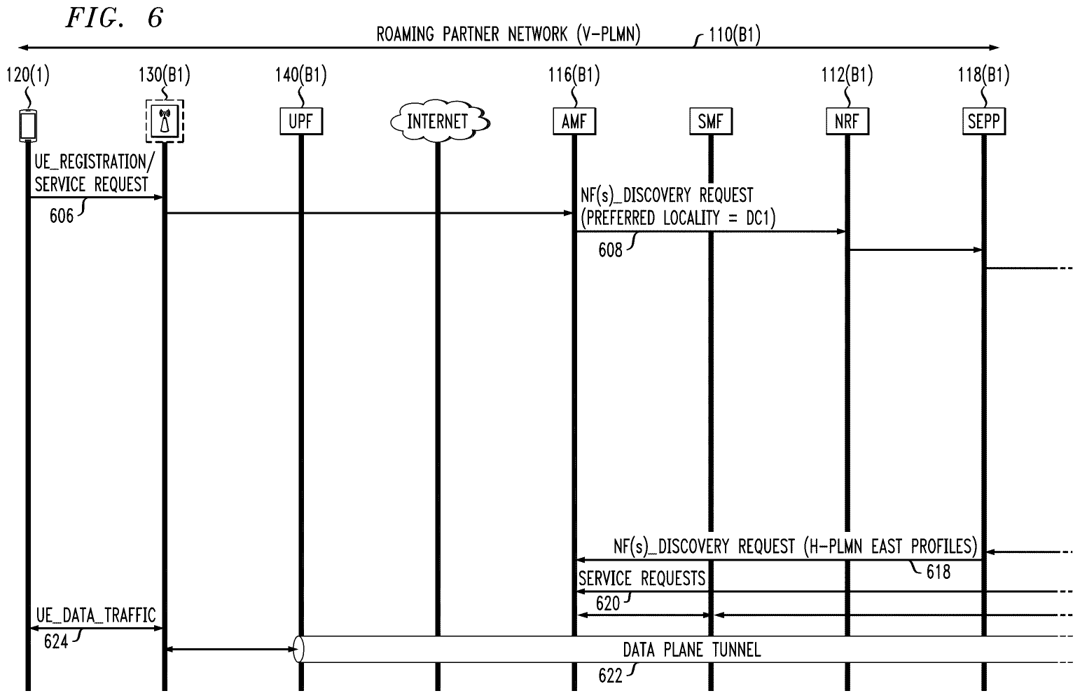

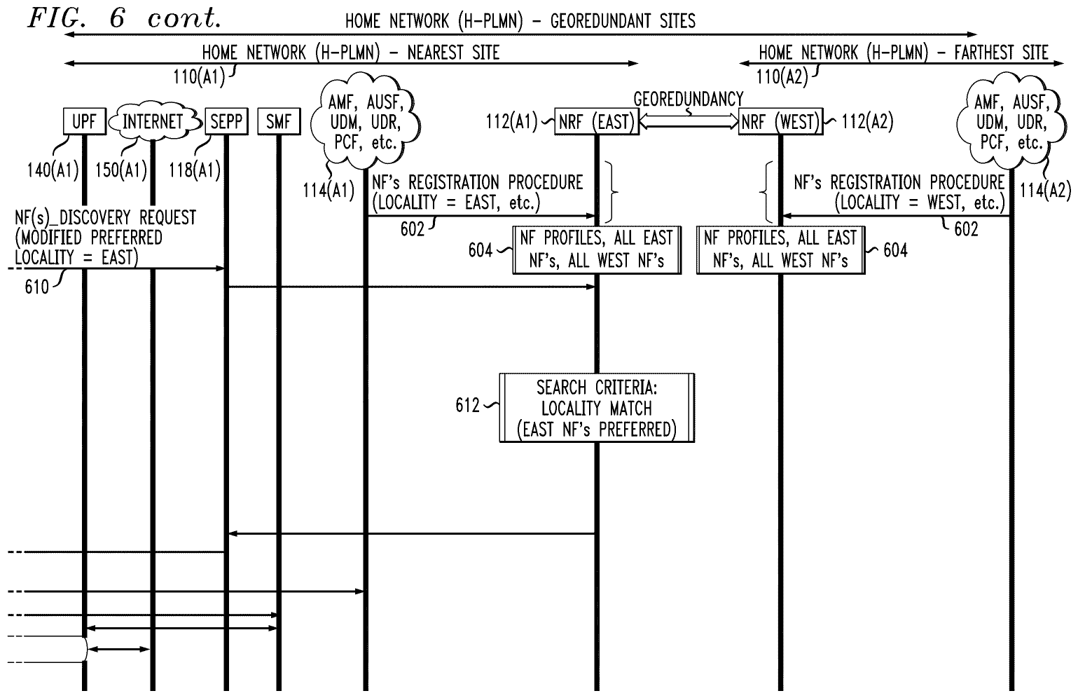

FIG. 6 is a message flow diagram representing the sequence of messages transmitted within and between the comm systems 100(A) and 100(B) of FIG. 4 for implementations in which the location information associated with UE 120(1) is coded at Operator B's NRF 112(B1). The steps of FIG. 6 are analogous to the similarly numbered steps of FIG. 5 with the following exceptions.

In Steps 606 and 608, explicit location information associated with UE 120(1) is not received by Operator B's NRF 112(B1). Rather, based on the coded relationship between Operator B's NDC 110(B1) and Operator A's NDC 110(A1) at Operator B's NRF 112(B1), in Step 610, Operator B's NRF 112(B1) explicitly identifies Operator A's NDC 110(A1) as the NDC to support UE 120(1)'s service request. As such, in Step 612, Operator A's NRF 112(A1) selects Operator A's NFs 114(A1) for UE 120(1).

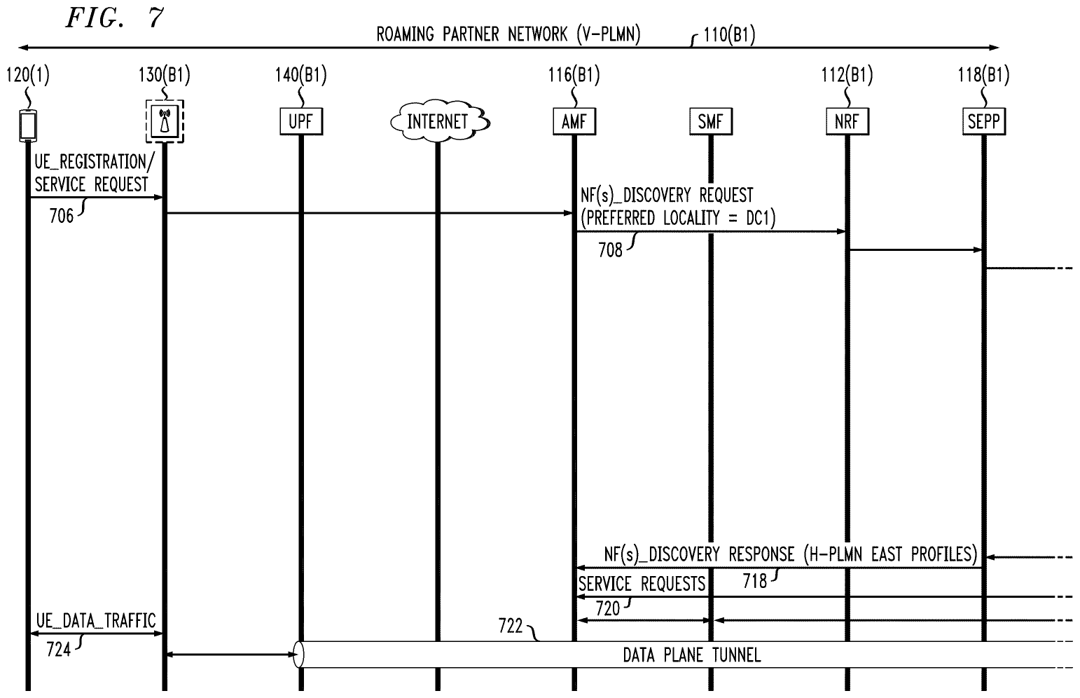

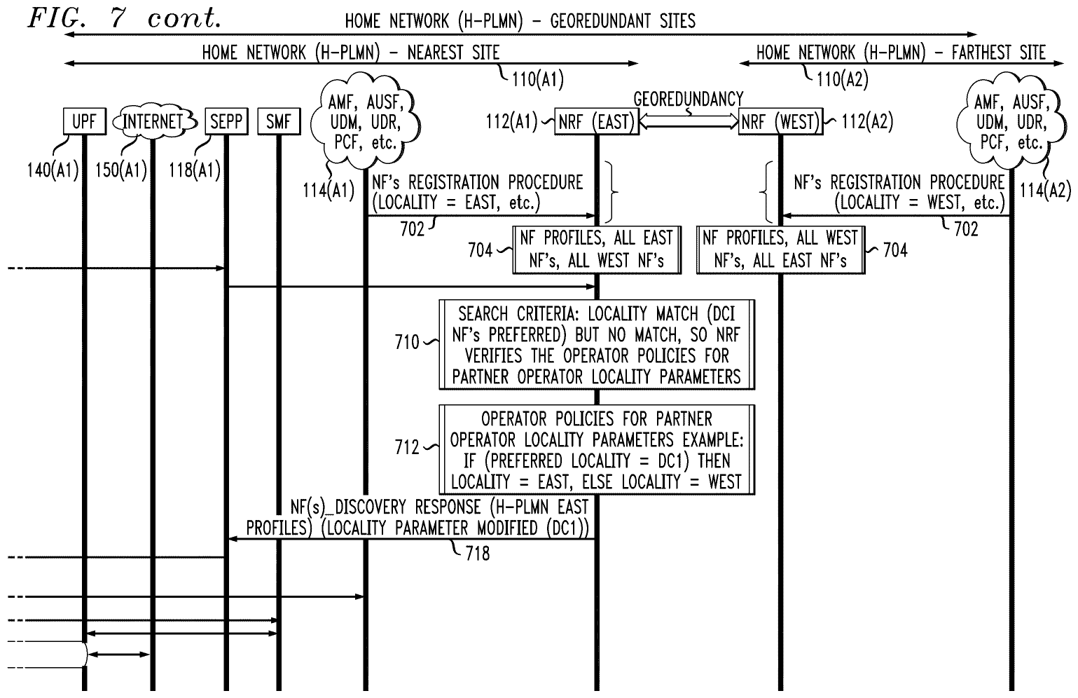

FIG. 7 is a message flow diagram representing the sequence of messages transmitted within and between the comm systems 100(A) and 100(B) of FIG. 4 for implementations in which the location information associated with UE 120(1) is coded at Operator A's NRF 112(A1). The steps of FIG. 7 are analogous to the similarly numbered steps of FIG. 5 with the following exceptions. After failing to recognize the preferred locality identified by Operator B's NRF 112(B1) in Step 710, in Step 712, Operator A's NRF 112(A1) refers to its coded relationship to identify Operator A's NFs 114(A1) for UE 120(1).

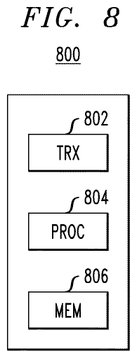

FIG. 8 is a simplified hardware block diagram of an example node 800 that can be used to implement any of the NDCs 110 of FIGS. 1-7. As shown in FIG. 8, the node 800 includes (i) communication hardware (e.g., wireless, wireline, and/or optical transceivers (TRX)) 802 that supports communications with other nodes, (ii) one or more processors (e.g., CPU microprocessors) 804 that controls the operations of and process data within the node 800, and (iii) memory (e.g., RAM, ROM) 806 that stores code executed by the processor 804 and/or data generated and/or received by the node 800.

Although the technology has been described in the context of comm system 100(A) having two NDCs 110(A1) and 110(A2), those skilled in the art will understand that the technology may be implemented in the context of comm systems having any suitable number of NDCs.

In certain embodiments, the present disclosure is a method for a first communication (comm) system having a roaming agreement with a second comm system, the first comm system comprising a plurality of network data centers (NDCs) having different locations. The method comprises a first NDC of the first comm system (i) receiving a request from the second comm system to provide network function (NF) service to user equipment (UE) of a customer of the first comm system; (ii) in response to the request, (a) selecting an NF in the first comm system for the NF service based on location information associated with the UE and (b) transmitting a response to the second comm system identifying the selected NF; and (iii) providing the NF service to the UE via the second comm system based the selected NF.

In at least some of the above embodiments, the first NDC of the first comm system receives the location information associated with the UE from the second comm system.

In at least some of the above embodiments, the first NDC of the first comm system requests the location information associated with the UE from the second comm system.

In at least some of the above embodiments, the first NDC of the first comm system receives the location information associated with the UE from the second comm system without requesting the location information associated with the UE from the second comm system.

In at least some of the above embodiments, the first NDC of the first comm system determines the location information associated with the UE based on the identity of the second comm system.

In at least some of the above embodiments, the second comm system has a plurality of NDCs; and the first comm system associates each NDC of the second comm system with a particular NDC of the first comm system such that the first NDC of the first comm system is associated with a corresponding NDC of the second comm system.

In at least some of the above embodiments, the request explicitly identifies the first NDC of the first comm system for the NF service based on the location information associated with the UE.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure. For example, a relatively thin layer of adhesive or other suitable binder can be used to implement such “direct attachment” of the two corresponding components in such physical structure.

As used herein in reference to an element and a standard, the terms “compatible” and “conform” mean that the element communicates with other elements in a manner wholly or partially specified by the standard, and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A method for a first communication (comm) system having a roaming agreement with a second comm system, the first comm system comprising a plurality of network data centers (NDCs) having different locations, the method comprises a first NDC of the first comm system:
receiving a request from the second comm system to provide network function (NF) service to user equipment (UE) of a customer of the first comm system;
in response to the request:
selecting an NF in the first comm system for the NF service based on location information associated with the UE and
transmitting a response to the second comm system identifying the selected NF; and
providing the NF service to the UE via the second comm system based the selected NF.

2. The method of claim 1, wherein the first NDC of the first comm system receives the location information associated with the UE from the second comm system.

3. The method of claim 2, wherein the first NDC of the first comm system requests the location information associated with the UE from the second comm system.

4. The method of claim 2, wherein the first NDC of the first comm system receives the location information associated with the UE from the second comm system without requesting the location information associated with the UE from the second comm system.

5. The method of claim 1, wherein the first NDC of the first comm system determines the location information associated with the UE based on the identity of the second comm system.

6. The method of claim 5, wherein:
the second comm system has a plurality of NDCs; and
the first comm system associates each NDC of the second comm system with a particular NDC of the first comm system such that the first NDC of the first comm system is associated with a corresponding NDC of the second comm system.

7. The method of claim 1, wherein the request explicitly identifies the first NDC of the first comm system for the NF service based on the location information associated with the UE.

8. A first network data center (NDC) for a first comm system having a roaming agreement with a second comm system, the first comm system comprising a plurality of NDCs having different locations, the first NDC comprising:
a memory; and
at least one processor, coupled to the memory and operative to:
receive a request from the second comm system to provide network function (NF) service to a UE of a customer of the first comm system;
in response to the request:
select an NF in the first comm system for the NF service based on location information associated with the UE; and
transmit a response to the second comm system identifying the selected NF; and
provide the NF service to the UE via the second comm system based the selected NF.

9. The first NDC of claim 8, wherein the first NDC is operative to receive the location information associated with the UE from the second comm system.

10. The first NDC of claim 9, wherein the first NDC of the first comm system is operative to request the location information associated with the UE from the second comm system.

11. The first NDC of claim 9, wherein the first NDC of the first comm system is operative to receive the location information associated with the UE from the second comm system without requesting the location information associated with the UE from the second comm system.

12. The first NDC of claim 8, wherein the first NDC of the first comm system is operative to determine the location information associated with the UE based on the identity of the second comm system.

13. The first NDC of claim 12, wherein:
the second comm system has a plurality of NDCs; and
the first comm system is operative to associate each NDC of the second comm system with a particular NDC of the first comm system such that the first NDC of the first comm system is associated with a corresponding NDC of the second comm system.

14. The first NDC of claim 8, wherein the request explicitly identifies the first NDC of the first comm system for the NF service based on the location information associated with the UE.
